(19) United States
(12) Patent Application Publication
(10) Pub. No.: US 2022/0252199 A1
(43) Pub. Date: Aug. 11, 2022

(54) CIPP LINER CURE TRUCK WITH MULTIPLE CURE TYPES

(71) Applicant: Joseph Taylor, Patterson, GA (US)

(72) Inventor: Joseph Taylor, Patterson, GA (US)

(21) Appl. No.: 17/526,991

(22) Filed: Nov. 15, 2021

Related U.S. Application Data
(60) Provisional application No. 63/113,191, filed on Nov. 13, 2020.

(51) Int. Cl. F16L 55/165; B29C 63/34; B29C 63/00

(52) U.S. Cl. CPC F16L 55/165; B29C 63/341; B29L 2023/22; B29C 63/0091; B29C 63/0069

(57) ABSTRACT

Pipe liner cure systems and trucks with multiple cure types and associated methods are described.

### RELATED APPLICATIONS

This application claims the benefit of U.S. Application No. 63/113,191, entitled “CIPP LINER CURE TRUCK WITH MULTIPLE CURE TYPES,” and filed on Nov. 13, 2020, which is incorporated herein by reference in its entirety.

### TECHNICAL FIELD

Embodiments relate generally to cured-in-place-pipe (CIPP) pipe liner curing equipment, and more particularly, to pipe liner cure trucks with multiple cure types.

### BACKGROUND

In some conventional curing processes for CIPP liners, a boiler truck is used for heating hot water to 180 F and recirculating the hot water through the installed CIPP in order to initiate the curing process. Some systems include a steam curing process during which a truck boils water from a water tank on the truck and a steam generator stores a large volume of steam pressure to use as a heat source of up to 250 F to cure CIPP liners. Both of these conventional systems use a large amount of diesel fuel to produce heat as a source to cure the liners.

Some implementations were conceived in light of the above-mentioned needs, problems and/or limitations, among other things.

### BRIEF DESCRIPTION OF THE DRAWINGS

FIG. 1 is a diagram of an example CIPP curing truck with heater and humidifier in accordance with some implementations.

FIG. 2 is a flowchart of an example method to control a CIPP curing truck with heater and humidifier in accordance with some implementations.

FIG. 3 is a diagram of an example CIPP curing truck with light source in accordance with some implementations.

FIG. 4 is a flowchart of an example method to control a CIPP curing truck with light source in accordance with some implementations.

FIG. 5 is a diagram of an example CIPP curing truck with electric current source in accordance with some implementations.

FIG. 6 is a flowchart of an example method to control a CIPP curing truck with electric current source in accordance with some implementations.

FIG. 7 is a diagram of an example computing device configured for electronic employment document control in accordance with at least one implementation.

### DETAILED DESCRIPTION

Some implementations can include methods and options to cure CIPP liners with one or more of heat, light, or electric current. The disclosed curing systems aid a contractor by providing capability to install CIPP liners with heat activated resin, UV resin, or electric current.

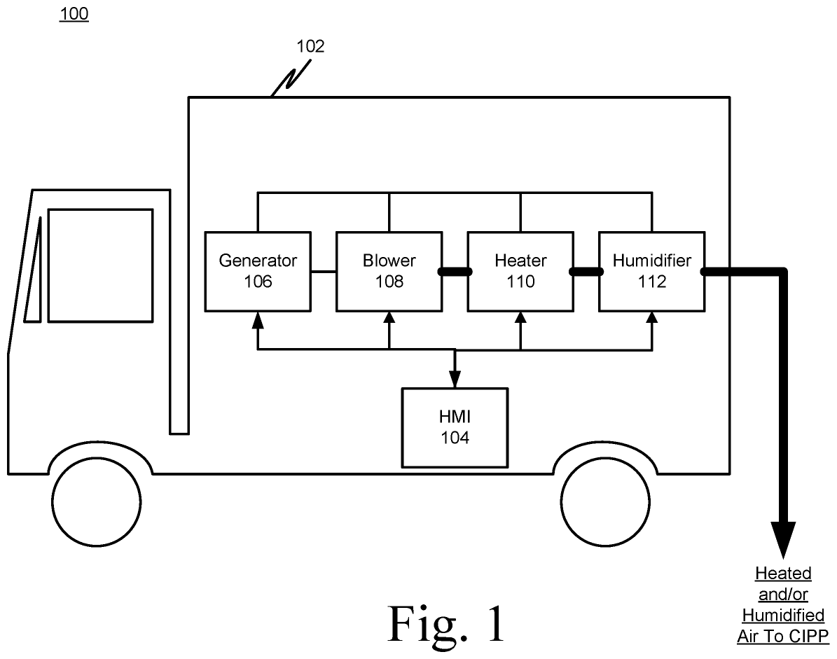

FIG. 1 is a diagram of an example CIPP curing system 100 including a truck 102 with heater and humidifier in accordance with some implementations.

The heat cure system can include a generator ranging, for example, from 48 kW to 120 kW 106 (e.g., a 60 kW industrial generator), a low pressure high volume blower ranging, for example, from 200 cfm to 850 cfm 108, an inline duct heating element for superheated hot air 110, a humidifier 112 to add water particles to be vaporized by the heater, and an HMI (Human Machine Interface) control system 104 that will all be housed or enclosed (insulated for noise reduction) in a utility truck body 102 for mobilization from job site to job site. The sequential order of these components will be the generator 106 first will supply power to the blower 108, heating element 110, humidifier 112, and HMI control system 104. Next, the HMI control system 104 provides full automation to the system and can include a digital readout to monitor and indicate that all components are powered up and ready to initiate procedure. With the HMI control system 104, the system can control the amount of cfm (cubic feet per minute) the blower will supply and control the ramp time and holding temperature of the heater and humidifier as the air is being supplied, among other things.

In operation, the system will gradually inflate a CIPP liner until the desired pressure is reached and then begin inducing the superheated air (or steam) to the liner. After the control system is setup, the blower 108 will then supply air, for example in the ranges of 0-850 cfm and 0-25 psi through a duct ranging from 1″-96″ (e.g., a 4″ duct) to the inline heating element 110, exiting the truck, and inflating the liner to the desired internal pressure. Once the desired internal pressure has been achieved, the heating element 110 will then superheat the air and the humidifier 112 will add moisture to the hot air causing it to vaporize or become steam (200F-250F or higher if needed to overcome heat loss) through another 4″ duct leaving from the inline heating element exiting towards the back end of the truck body. An additional hose will be connected to this exit duct coming from the heating element and will also be connected to the end cap that is attached to the liner that will be receiving the superheated air. The liner will have a plastic film bladder as the inner most layer which has already been inflated and now has the superheated air supplied to it from the inline heater on the truck. By this time, the bladder will have already expanded and compressed the liner material to the inner diameter of the wall of the host pipe in which the heat is now being transferred to the material initiating the cure process of the liner material (e.g., liner material including heat activating resins).

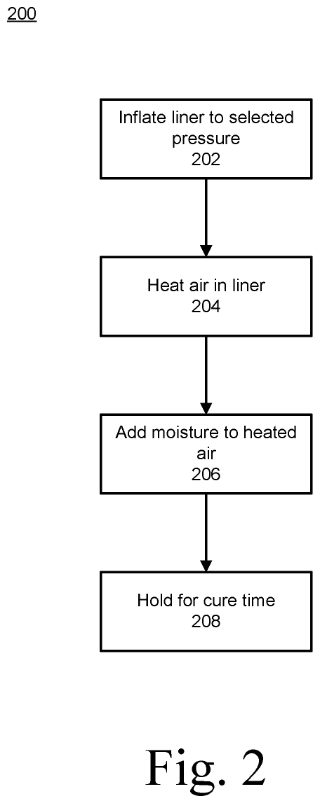

FIG. 2 is a flowchart of an example method to control a CIPP curing truck with heater and humidifier in accordance with some implementations. The method begins at 202, where a CIPP liner is inflated by a blower (e.g., 108) to a selected pressure (e.g., selected using the HMI 104). The method continues to 204.

At 204, the air in the liner is heated (e.g., using the heater 110). The method continues to 206.

At 206, moisture is optionally added to the heated air (e.g., using the humidifier 112). The method continues to 208.

At 208, the heated and/or humid air is held in the liner for a cure time period.

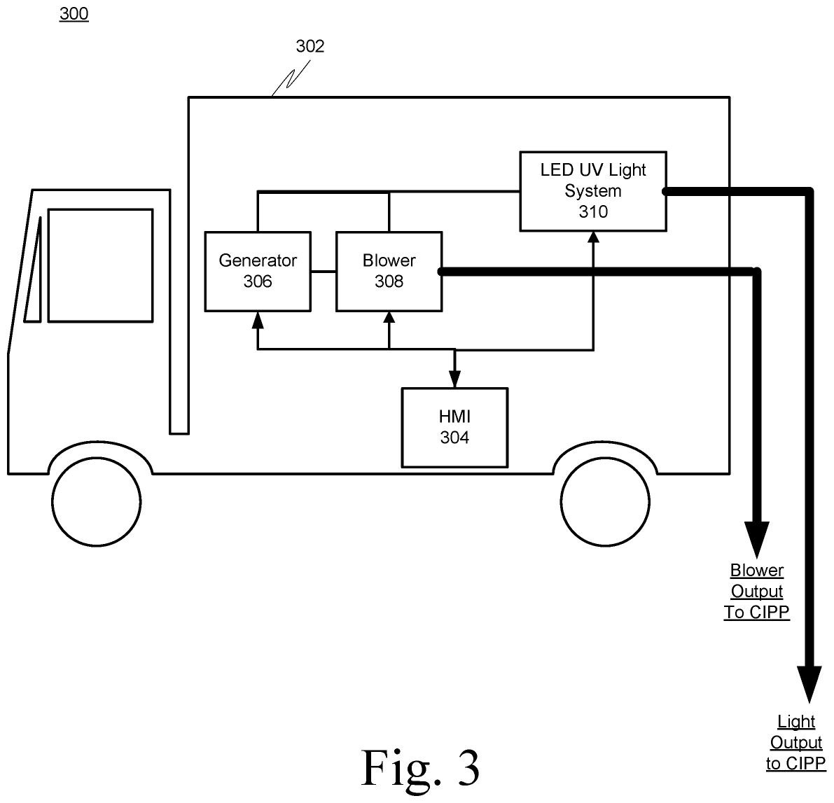

FIG. 3 is a diagram of an example CIPP curing system 300 including a truck 302 with light source in accordance with some implementations. The UV light cure system 300 can include a generator 306 (e.g., similar to 106), a low pressure high volume blower 308 (e.g., similar to 108), an HMI control system 304, and 1000′ spool of cable (not shown) that connects to a UV LED invertible light chain system 310. The HMI control system 304 will allow the operator to select which type of liner is being cured and once the UV cure system is selected, the inline heater will be disabled and power to the UV LED light system 310 will be enabled. Conveniently, the heat cure process is not much different from the UV cure process, so similar steps as above will be involved except instead of adding steam, a light chain will be introduced and pulled thru the liner while inflated to the desired pressure. The desired pressure is the same as the steam cure process 0-25 psi and once the UV LED light chain is installed, it is pulled back under pressure and the liner is cured in place at this pressure from one end to the other. Once the liner is cured from start to finish, the light chain is removed and both ends of the cured liner is cut flush with existing pipe and the host pipe is reinstated.

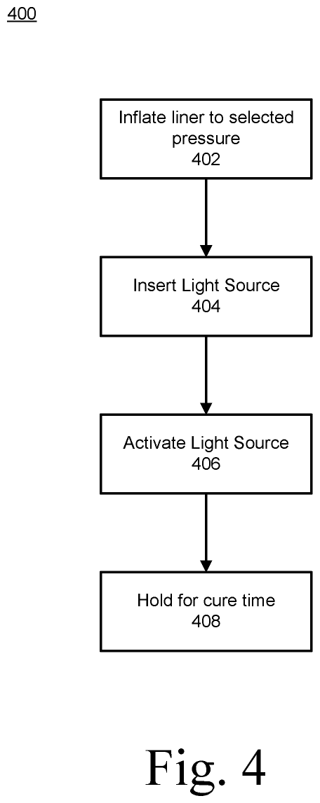

FIG. 4 is a flowchart of an example method to control a CIPP curing truck with light source in accordance with some implementations. The method begins at 402, where the liner is inflated to a selected pressure (e.g., selected via the HMI 304). The method continues to 404.

At 404, a light source is inserted into the liner. The light source can include an LED UV light chain (e.g., 310) or other suitable light source for curing the liner material. The method continues to 406, where the light source is activated. The method continues to 408.

At 408, the pressure and light source in the liner are maintained for a cure time period.

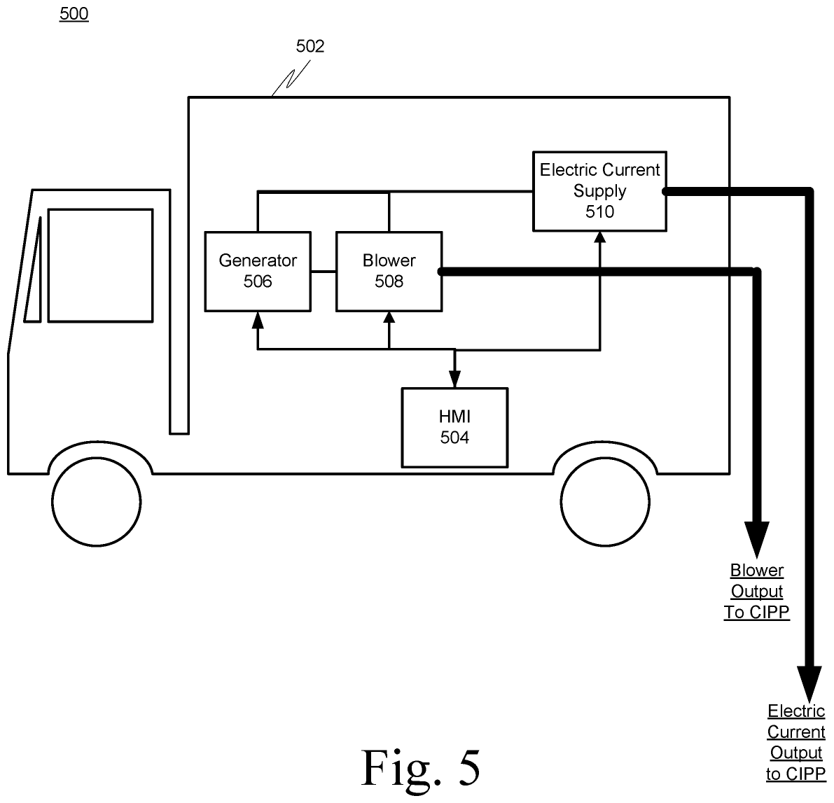

FIG. 5 is a diagram of an example CIPP curing system 500 including a truck 502 with electric current source in accordance with some implementations. In addition to the current CIPP curing processes, an electrically activated liner can be used. Presently, conventional CIPP liners are saturated with thermosetting resins such as epoxy, polyester, and/or vinyl ester. A newly developed liner includes thermoplastic fiber integrated with a reinforced fiber to serve as a dry pre-pregnated system. This means that the liner is already saturated with a resin that is comingled with a fiber reinforcement and that once heated to the proper temperature and pressure, the resin will melt and bond to the surrounding fibers. Then the heat is removed, and the matrix is allowed to cool back down. The system 500 includes a generator 506, blower 508, HMI control system 504, and a heated bladder or liner material that can carry electrical current, which will be incorporated during the manufacturing process so that once the liner is installed and ready to inflate, this truck will be able to provide an electric current from an electric current supply 510 to the bladder or fiber material, which will conduct heat to the entire liner uniformly so that the thermoplastic resin will melt and bond to the fibers uniformly or thermoset resin will be initiated until the liner has had its proper dwell time and is allowed to cool down. The electrical current curing process is similar to both liners above, air is introduced to the bladder or coating which compresses the material to the inner diameter of the host pipe. Once inflation is complete and desired pressure is achieved, the bladder or fiber material which has heating elements inside the bladder will supply the desired heat to the beginning and end of liner simultaneously allowing the liner to cure uniformly and giving the operator a specific time frame and controlled heat to allow for a proper cure per thickness of material. Once the liner has been exposed to the proper amount of heat for the proper amount of time, then a cool down period proceeds the heating process. After the cool down process, the heated bladder is removed or can stay in-place, the ends of the liner are cut flush with existing pipe, and the host pipe is reinstated back to service. The heated bladder can still be used for the conventional liners as well as the dry pre-pregnated liners as a source of heat to initiate the curing process.

The trucks described above include numerous advantages such as minimizing the footprint of the size of this truck by using an inline heater which eliminates the need of a 120 hp steam generator which also requires a 1,000 gal water tank which also burns 30-60 gals of diesel fuel per hour, the truck itself can be reduced down to only having to haul the weight of the 60 kW generator and a 20 kW rotary vane blower which if placed properly, excess space can be utilized to add another curing system if the customer desires because the other methods of curing require electricity and the 60 kW generator will be more than enough power to run that equipment. Also, conventional CIPP liner curing trucks may only have enough space on the trucks to supply one curing method (e.g., heated air or water) because of the size of the existing equipment. The disclosed trucks are a more streamlined system that can accommodate more than one curing technique (e.g., heated air, heated water, light, or electric current, or a combination of the above) and still provide the required heat and/or power, but with more efficiency. A liner curing truck can include more than one curing technique (e.g., heated air, heated water, light, or electric current, or a combination of two or more the above) and can use more than one curing technique during a given curing operation depending on the type of CIPP liner and the application.

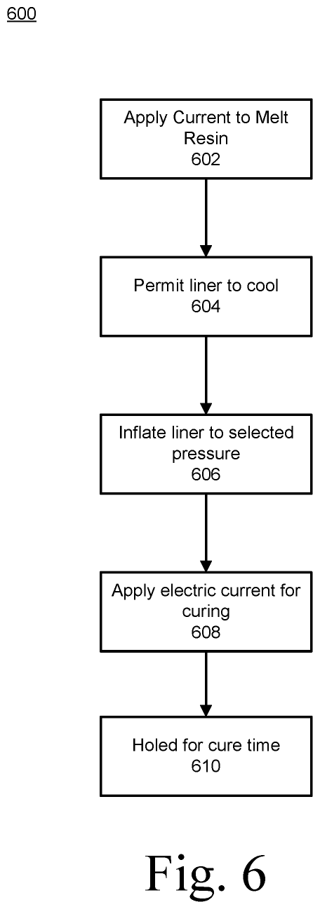

FIG. 6 is a flowchart of an example method to control a CIPP curing truck with electric current source in accordance with some implementations. The method begins at 602 where electric current is applied to melt the dry resin material in the liner. The method continues to 604.

At 604, the liner is permitted to cool for a given period of time. The method continues to 606.

At 606, the liner is inflated to a selected pressure. The method continues to 608.

At 608, electric current is again applied to the liner for the curing process. The method continues to 610.

At 610, the pressure and current are maintained for a curing time period.

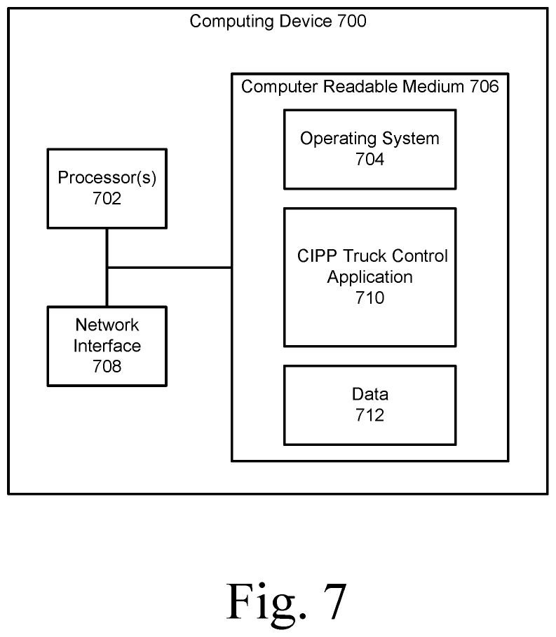

FIG. 7 is a diagram of an example computing device 700 for implementing an HMI as described above in accordance with at least one implementation. The computing device 700 includes one or more processors 702, nontransitory computer readable medium 706 and network interface 708. The computer readable medium 706 can include an operating system 704, an application 710 to control CIPP liner curing and a data section 712 (e.g., for configuration settings, etc.).

In operation, the processor 702 may execute the application 710 stored in the computer readable medium 706. The application 710 can include software instructions that, when executed by the processor, cause the processor to perform operations to cure a CIPP liner in accordance with the present disclosure (e.g., performing associated functions described in FIGS. 2, 4, and 6).

The application program 710 can operate in conjunction with the data section 712 and the operating system 704 to provide human-machine interface functions and curing equipment control functions as described above.

Curing trucks can include equipment for one type of curing (e.g., as shown in FIGS. 1, 3, and 5) or for two or more types of curing. For example, a truck can include the equipment from both 100 and 300, both 100 and 500, both 300 and 500, or all of 100, 300 and 500.

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C#.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering and computer networking arts.

Moreover, embodiments of the disclosed method, system, and computer readable media (or computer program product) can be implemented in software executed on a programmed general purpose computer, a special purpose computer, a microprocessor, a network server or switch, or the like.

It is, therefore, apparent that there is provided, in accordance with the various embodiments disclosed herein, CIPP liner curing trucks and methods, systems and computer readable media to control the CIPP liner curing process.

While the disclosed subject matter has been described in conjunction with a number of embodiments, it is evident that many alternatives, modifications and variations would be, or are, apparent to those of ordinary skill in the applicable arts. Accordingly, Applicants intend to embrace all such alternatives, modifications, equivalents and variations that are within the spirit and scope of the disclosed subject matter.

1. A heat cure system comprising:
a generator configured to supply electrical power;
a blower coupled to the generator to receive electrical power from the generator;
an inline duct heating element to generate superheated hot air, the inline duct heating element coupled to the generator to receive electrical power from the generator and coupled to the blower to receive air from the blower;
a humidifier coupled to the generator to receive electrical power from the generator and to the inline duct heating element to receive superheated hot air from the inline duct heating element and add humidity to the superheated hot air;
a control system coupled to the generator, the blower, the inline duct heating element and the humidifier, wherein the control system is configured to control the heat cure system to cure a cure in place pipe liner.
